(19) United States
(12) Patent Application Publication
(10) Pub. No.: US 2011/0135199 A1
(43) Pub. Date: Jun. 9, 2011

(54) CODING APPARATUS AND METHOD FOR SIMULTANEOUS TRANSMISSION OF IMAGE PROCESSING INFORMATION AND COLOR INFORMATION

(75) Inventors: Seung Min CHOI, Daejeon (KR); Jiho Chang, Daejeon (KR); Jae Il Cho, Daejeon (KR); Dae Hwan Hwang, Daejeon (KR)

(73) Assignee: ELECTRONICS AND TELECOMMUNICATIONS RESEARCH INSTITUTE, Daejeon (KR)

(21) Appl. No.: 12/785,766

(22) Filed: May 24, 2010

(30) Foreign Application Priority Data
Dec. 8, 2009 (KR) 10-2009-0121437

(51) Int. Cl. G06K 9/36

(52) U.S. Cl. 382/166

(57) ABSTRACT

A coding apparatus for simultaneous transmission of image processing information and color information includes: an image sensor for photographing a color image; and an image preprocessing device for performing image processing on the photographed color image, and then encoding image processing result data and the color image to output encoded data. Further, the coding apparatus for simultaneous transmission of image processing information and color information includes a central processing unit for decoding the encoded data to extract the image processing result data and the color image.

### CROSS-REFERENCE TO RELATED APPLICATIONS

The present invention claims priority to Korean Patent Application No. 2009-0121437 filed on Dec. 08, 2009, which is incorporated herein by reference.

### FIELD OF THE INVENTION

The present invention relates to an image processing technology for use in a camera device; and more particularly, to a coding apparatus and method for simultaneous transmission of image processing information and color information, which are suitable for encoding image processing information and color information obtained from a camera device into one image of YCbCr 4:2:2 format, and transmitting the encoded image to a central processing unit (CPU), and decoding a received image back into image processing information and color information.

### BACKGROUND OF THE INVENTION

Recently, as the need for a new user interface (UI) taking the operation or motion of people as an input increases, the researches for cameras to output various image processing results have been actively conducted. In particular, representative examples of such researches include laser sensors of high price widely used in the industrial field, time of flights (TOFs) that are recently commercialized and used as a user interface of game machine and the like, and three-dimensional (3D) cameras of stereo visions and the like that are utilized in an intelligent robot field or image recognition field. Moreover, cameras or dedicated chips (e.g., application specific integrated circuit (ASIC)) that output the result of pixel unit obtained by applying diverse filters to an original image and the like are being introduced.

Such 3D cameras convert a distance from a photographing lens to an object to be photographed into a distance value based on required resolution and resolving ability to output it, so that a central processing unit can implement various applications using the result and 2D color information.

For instance, when 3D information of a user is obtained, the background and foreground can be separated from each other. The foreground may be the figure of the user. Using a region of interest (ROI) that provides only the figure of the user, user tracking can be performed. At this time, in order to know the fact that the foreground is a person, a face detector, a flesh-colored detector, or the like can be necessary. Further, a facial expression or gesture can be recognized by detecting a hand or face.

As mentioned above, to apply 3D information of a 3D camera to a user interface, there are lots of applications of actually requiring 2D color information, in addition to distance information. Therefore, a 3D camera of simultaneously outputting 2D color information and 3D distance information will be described below.

Most of currently commercialized complementary metal-oxide semiconductor (CMOS) and charge couple device (CCD) cameras support YCbCr 4:2:2 and RAW RGB formats for color output. Thus, for various embedded processors interfaced with these types of cameras, a camera sensor interface (CSI) has been implemented to receive image data of YCbCr 4:2:2, RGB888 and the like.

YCbCr 4:2:2 that is widely used due to excellent color reproduction relative to bandwidth transmits color information and distance information as an output of 3D camera. Here, YCbCr indicates a kind of color space used in an image system, where Y denotes a luminance component, and Cb and Cr indicate a color difference component. YCbCr may be sometimes abbreviated to YCC. YCbCr is not an absolute color space but one of methods of encoding RGB information, and image color to be actually represented depends on original RGB information used to display signals. Therefore, a value represented in YCbCr can be predicted only when standard RGB color is used or an ICC profile used to convert color is added.

Meanwhile, the ITU-R BT.601 standard defining a YCbCr 4:2:2 format defines encoding parameters of digital television for a studio. This is an international standard used for digitalizing a component color television image that is commonly used for 525 line and 625 line systems, and is originated from SMPTE RP125 and EBU Tec. 3246-E. CCIR 601 deals with both color difference signals (Y, R−Y and B−Y) and an R·G·B video, and defines a sampling system and matrix values of R·G·B/Y, (R−Y) and (B−Y) and filter characteristics but does not define an electric/mechanical interface (see CCIR 656). It is regarded that CCIR 601 generally refers to a color difference component (not R·G·B) of digital image, and is defined as 13.5 MHz bandwidth, 4:2:2 sampling, 720 luminance sampling per effective line, and 8- or 10-bit digitalization. There is a little of headroom to minimize clipping of noise and overshoot between black level 16 and white level 235. Using 8bit digitalization, colors of about 1600 ten thousands can be expressed. Y (luminance) component and Cr and Cb (digitalized R-Y and B-Y) are each 28, where a combination of ‘224=16,777,216’ is available.

The sampling frequency of 13.5 MHz is selected to provide the sampling standardization that is commonly used for 525/60 system and 625/50 system, and is a multiple of a minimum common frequency of 2.25 MHz that provides the statistical sampling pattern of both systems.

FIG. 1 shows the structure of a general YCbCr 4:4:4 format, FIG. 2 illustrates the structure of a YCbCr 4:2:2 format, and FIG. 3 illustrates the structure of a YCbCr 4:2:0 format.

First, referring to FIG. 1, in YCbCr 4:4:4 mapping in 1:1 with RGB888 format, respective 8 bits of Y, Cb and Cr are assigned to respective pixels. The total 24 bits per one pixel are assigned, and four pixels of 100-P11, 100-P12, 100-P21 and 100-P22 are included in one group 100. Further, YCbCr 4:2:2 shown in FIG. 2 is a down-sampled format from YCbCr 4:4:4, to have color difference information, which is relatively less sensitive to eyes of the human being, in units of even or odd pixel in a transverse direction.

In the group 100 of FIG. 1, Cb and Cr of 100-P11 and 100-P12 are calculated as an arithmetic mean, and are included only in 200-P11 of FIG. 2. When converting this information into YCbCr 4:4:4, Cb and Cr of 200-P11 may be used as Cb and Cr of 200-P12. That is, down-sampling Cb and Cr from YCbCr 4:4:4 in a transverse direction becomes YCbCr 4:2:2.

Similarly, when down sampling YCbCr 4:2:2 in a length direction, YCbCr 4:2:0 has a structure that Cb and Cr values are in 300-P11 in a group 300 as shown in FIG. 3, and that the rest three pixels 300-P12, 300-P21 and 300-P22 have only Y value.

These methods utilize the characteristic that Cb and Cr are less sensitive to eyes of the human being compared with Y value. Most of CMOS and CCD cameras support YCbCr 4:2:2 output, and encoders of the image compression group of MPEG, H.26X, JPEG and the like used in DVD or photos of digital camera use YCbCr 4:2:0 as an input.

As described above, the 3D camera using the image format of YCbCr 4:2:2, YCbCr 4:2:0 and the like generally transmits and receives color image information and other image-processed information of pixel unit by using two buses, respectively, and processes the two information received through one central processing unit.

However, the camera having the conventional image processing function that operates like the 3D cameras illustrated as one example needs to transmit and receive photographed color image information from the camera and other image-processed information of pixel unit by using two buses, respectively, and needs to then establish a synchronization between frames of respective information or simultaneously perform image processing at one central processing unit receiving a color image, thus requiring much processing time and causing an overload to the central processing unit.

### SUMMARY OF THE INVENTION

In view of the above, the present invention provides a coding apparatus and method for simultaneous transmission of image processing information and color information, which are capable of transmitting and receiving, and decoding two kinds of data output from a device that simultaneously outputs a color image and an image processing result data through one bus.

More specifically, the present invention provides a coding apparatus and method for simultaneous transmission of image processing information and color information, which are capable of receiving encoded YCbCr 4:2:2 format data from a camera that outputs a color image and an image processing result data of pixel unit by a central processing unit via a bus, and decoding the YCbCr 4:2:2 format data by the central processing unit, to thereby extract color information of YCbCr 4:2:0 and distance information.

In accordance with a first aspect of the present invention, there is provided a coding apparatus for simultaneous transmission of image processing information and color information, the apparatus including: an image sensor for photographing a color image; an image preprocessing device for performing image processing on the photographed color image, and then encoding image processing result data and the color image to output encoded data; and a central processing unit for decoding the encoded data to extract the image processing result data and the color image.

In accordance with a second aspect of the present invention, there is provided a coding method for simultaneous transmission of image processing information and color information, the method including: photographing a color image by an image sensor; performing, at an image preprocessing device, image processing on the photographed color image, and then encoding image processing result data and the color image; and decoding, at a central processing unit, the encoded data to extract the image processing result data and the color image.

As described above, in the coding apparatus and method for simultaneous transmission of image processing information and color information in accordance with the embodiment of the present invention, two kinds of data output from a device that simultaneously outputs a color image and an image processing result data are transmitted and received via one bus and then decoded. In other words, in the central processing unit, encoded data of YCbCr 4:2:2format is received from a 3D camera via a bus, and then decoded to extract color information of YCbCr 4:2:0 and distance information.

As a result, in the coding apparatus and method for simultaneous transmission of image processing information and color information in accordance with the embodiment of the present invention, in the case of a device that simultaneously outputs a color image and an image processing result data, since two kinds of data can be transmitted and received via one bus only, unnecessary memory, signal lines and synchronization device required when using additional bus can be saved.

Further, the image processing result data may be reproduced in a picture in picture (PIP) type for working division between devices, and then transmitted and received with a high resolution. In this case, however, there is a problem of bandwidth as well as the need of a frame buffer for the PIP. Accordingly, it can be advantageous to apply the present invention.

### BRIEF DESCRIPTION OF THE DRAWINGS

The objects and features of the present invention will become apparent from the following description of embodiments, given in conjunction with the accompanying drawings, in which:

FIG. 1 shows the structure of a conventional YCbCr 4:4:4 format;

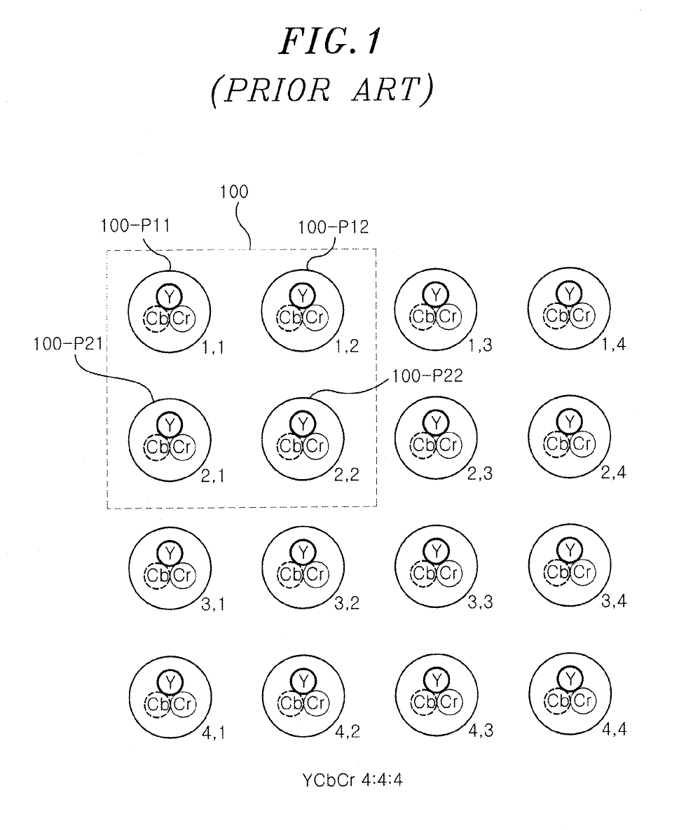

FIG. 2 shows the structure of a conventional YCbCr 4:2:2 format;

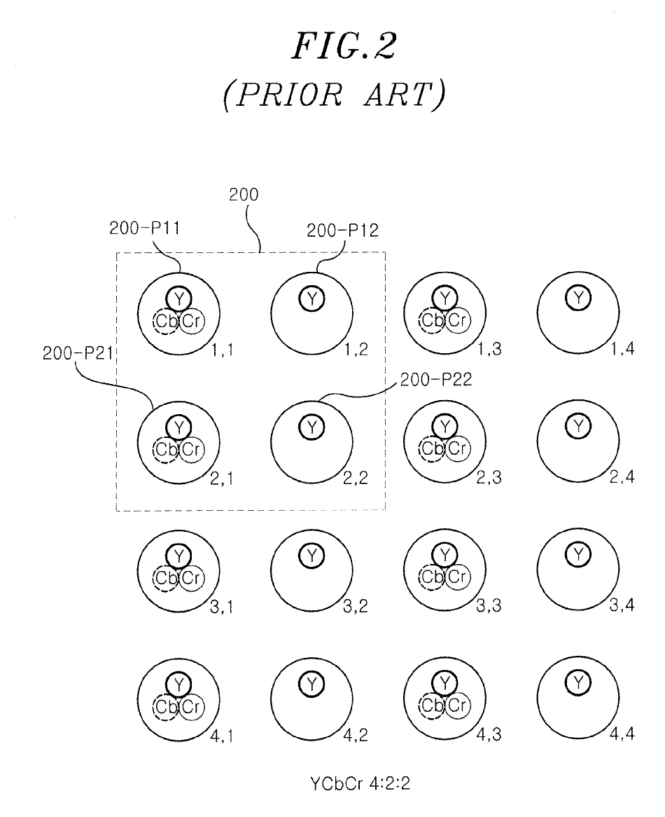

FIG. 3 shows the structure of a conventional YCbCr 4:2:0 format;

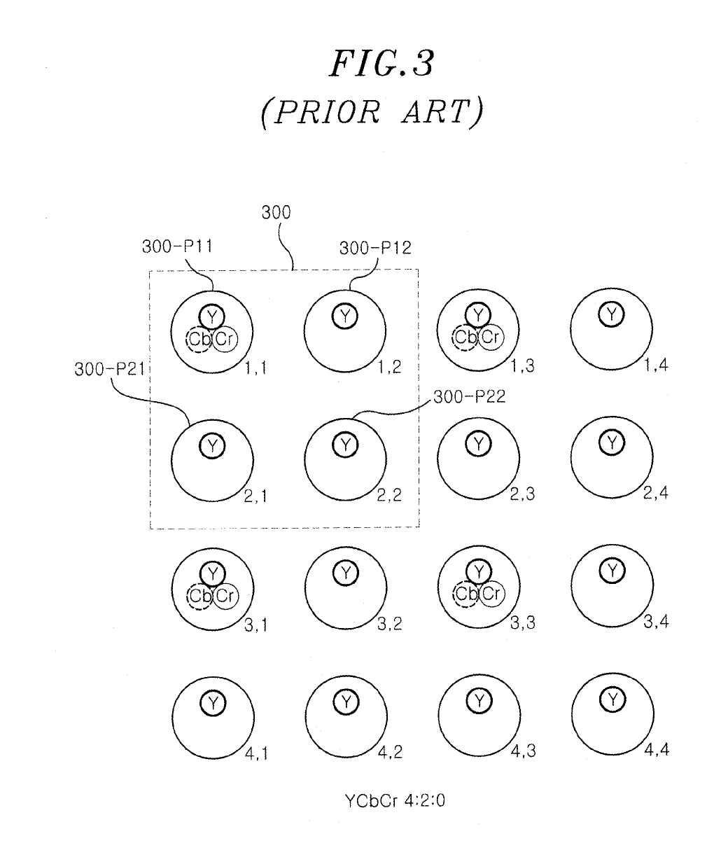

FIG. 4 illustrates the structure of a new YCbCr 4:2:2 format that stores both color information and distance information in accordance with an embodiment of the present invention;

FIG. 5 is an enlarged view of the structure of a group having a new YCbCr 4:2:2 format in accordance with the embodiment of the present invention;

FIG. 6 is a block diagram illustrating the configuration of a coding apparatus for simultaneous transmission of image processing information and color information in accordance with the embodiment of the present invention; and

FIG. 7 is a flow chart illustrating an operational procedure of the coding apparatus for simultaneous transmission of image processing information and color information in accordance with the embodiment of the present invention.

### DETAILED DESCRIPTION OF THE EMBODIMENTS

Hereinafter, embodiments of the present invention will be described in detail with reference to the accompanying drawings which form a part hereof.

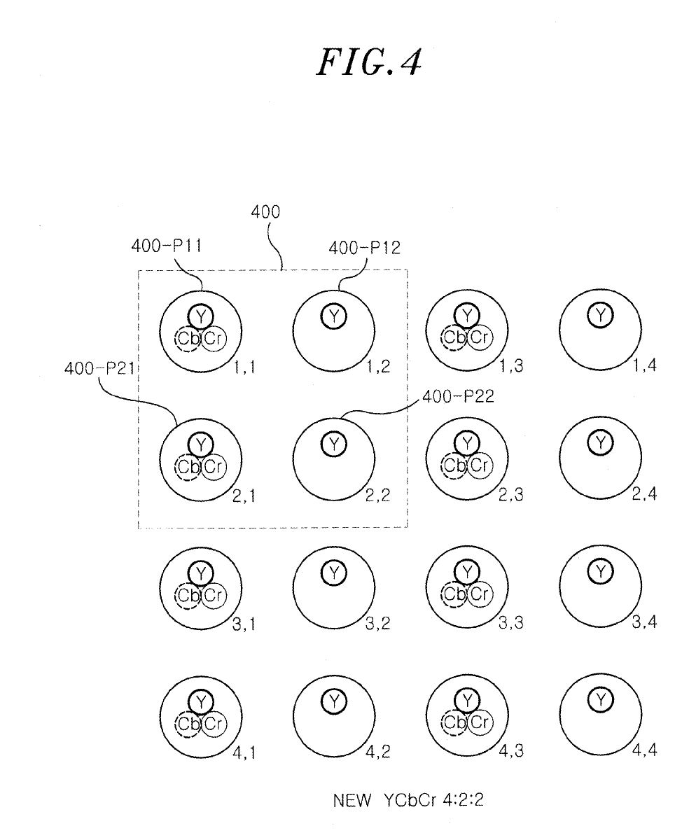

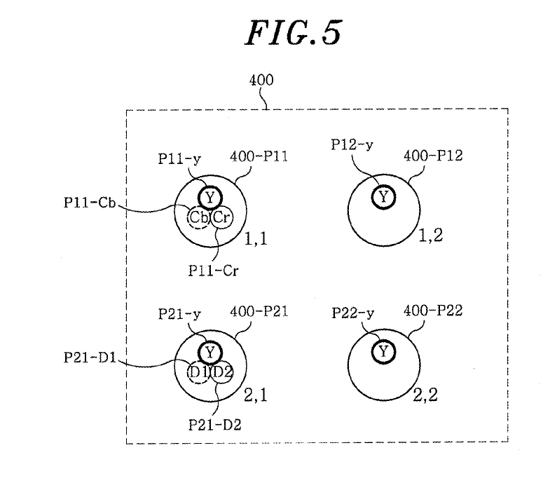

FIG. 4 illustrates the structure of a new YCbCr 4:2:2 format that stores both color information and distance information in accordance with an embodiment of the present invention, and FIG. 5 is an enlarged view of the structure of a group having the new YCbCr 4:2:2 format.

Referring to FIG. 4, a group 400 of a new YCbCr4:2:2 format includes four pixels of 400-P11, 400-P12, 400-P21 and 400-P22. That is, as shown in FIG. 5, as color information in the group 400, there are four Y values (P11-Y, P12-Y, P21-Y and P22-Y), and one Cb(P11-cb) and one Cr(P11-cr). Thus, this is the YCbCr 4:2:0 format that four pixels share Cb(P11-cb) and Cr(P11-cr). Further, in 400-P21, there exist additionally D1(P21-D1) and D2(P21-D2), which correspond to an image processing result data, i.e., distance information. As stated above, since there is two distance information for four pixels, it is a type that 240 distance information exists when performing a down sampling in a length direction.

That is, FIG. 4 is the YCbCr 4:2:2 format with resolution of 640×480, and the contents thereof are composed of color information of 640×480 YCbCr 4:2:0 and distance information of 256 levels per pixel of 640×240. This data is transmitted from a camera to a central processing unit through a data bus interface of ITU-R BT.656. Then, the central processing unit decodes the data into color information and distance information to be used in applications requiring them.

Meanwhile, the international telecommunication union-radio communication sector (ITU-R) BT.601 and ITU-R BT.656 based on the communication protocol standardized by ITU-R may be employed as a transmission interface for an image photographed by a camera. Particularly, the ITU-R BT.656 is mainly used because it represents a synchronization signal, effective sections, and so on in data in a specific data form.

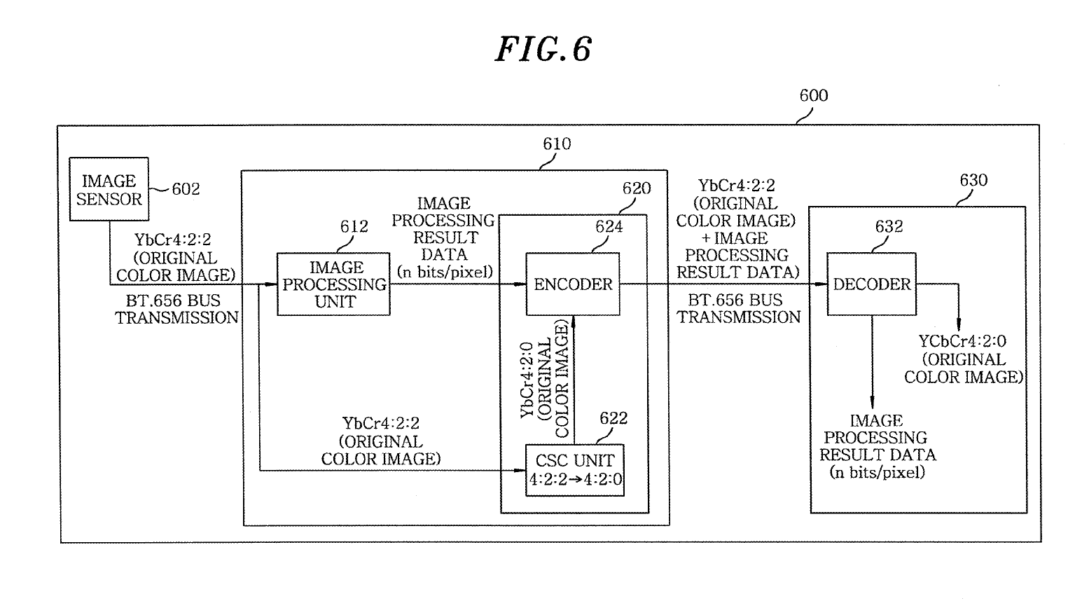

FIG. 6 is a block diagram illustrating the configuration of a coding apparatus for simultaneous transmission of image processing information and color information in accordance with an embodiment of the present invention.

Referring to FIG. 6, the coding apparatus 600 for simultaneous transmission of image processing information and color information includes an image sensor 602, an image preprocessing device 610, and a central processing unit 630. As shown therein, the image preprocessing device 610 includes an image processing unit 612, an encoding unit 620, a color space conversion (CSC) unit 622, and an encoder 624. The central processing unit 630 includes a decoder 632.

To be more specific, the image sensor 602 may be a semiconductor such as CMOS or CCD, and generates an original color image (YCbCr 4:2:2) by converting an analog signal of an image formed by light receiving in the CCD or CMOS into a digital signal, and then transfers the digital signal to the image preprocessing device 610 via an ITU-R BT.656 data bus interface.

The image preprocessing device 610 first transfers the original color image (YCbCr 4:2:2) to the image processing unit 612 and the encoding unit 620. Then, the processing unit 612 outputs image processing result data by performing image processing on the original color image (YCbCr 4:2:2) by an image processor. That is, the image processing unit 612 performs processing of the image by applying predetermined values for image optimization or picture control, picture style, or the like, converts a distance from a photographing lens of CMOS or CCD to an object to be photographed into a distance value based on preset resolution and dissolution activity, and outputs it.

At this time, the distance value may be calculated by using multiple photo images photographed with a predetermined time difference or multiple photo images with different horizontal distances. To this end, the image sensor 602 having at least two lens, or at least two image sensors 602 may be used.

That is, the image processing unit 612 removes noise of the original color image (YCbCr 4:2:2), adjusts a white balance, and controls colors, saturation and contrast depending on basic setting values or user setting values. Further, the image processing unit 612 calculates a distance value and outputs image processing result data.

The encoding unit 620 transfers the original color image (YCbCr 4:2:2) to the CSC unit 622, which converts a format of the original color image (YCbCr 4:2:2) to generate a color image (YCbCr 4:2:0). This result is obtained by down-sampling the original color image (YCbCr 4:2:2) in a length direction, wherein four Y values and one Cb value and one Cr value exist in four pixel groups.

The color image YCbCr 4:2:0 converted by the CSC unit 622 is then transferred to the encoder 624, then the encoder 624 carries out encoding on the received color image (YCbCr 4:2:0) and the image processing result data output from the image processing unit 612. At this time, the encoder 624 includes, distance information included in the image processing result data encoded by YCbCr 0:0:2 format, in the color image (YCbCr 4:2:0), i.e., color information to encode into a new color image (YCbCr 4:2:2) format.

In the data of this new color image (YCbCr 4:2:2), four Y values exist, one Cb value and one Cr value exist, and two distance information exists, in four pixel groups.

Meanwhile, the data encoded into the new color image (YCbCr 4:2:2) format by the encoder 624 is then transmitted to the central processing unit 630 via an ITU-R BT.656 data bus interface.

Then, the central processing unit 630 performs decoding on the new color image (YCbCr 4:2:2) data by the decoder 632 to output a color image (YCbCr 4:2:0) and an image processing result data. This is to separately extract distance information from the new color image (YCbCr 4:2:2). The separated color image (YCbCr 4:2:0) and the image processing result data can be used in various applications, e.g., separation of background and foreground and person's extraction through face recognition from the foreground, extraction of specific activity of personand the like.

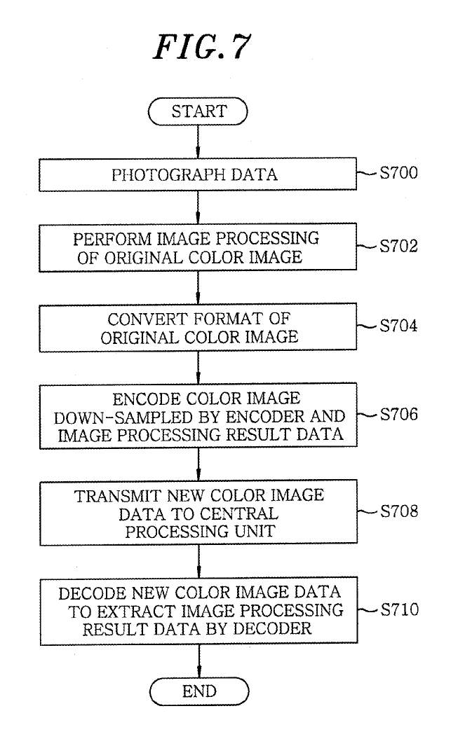

FIG. 7 is a flow chart illustrating an operational procedure of the coding apparatus for simultaneous transmission of image processing information and color information in accordance with the embodiment of the present invention.

Referring to FIG. 7, data photographed by the image sensor 602 in step S700 is transmitted as original color image (YCbCr 4:2:2) data to the image preprocessing device 610, and image processing result data including distance information is output from the original color image (YCbCr 4:2:2) data by the image processing unit 612 in step S702.

The original color image (YCbCr 4:2:2) data is then transferred to the encoding unit 620 of the image preprocessing device 610, and the original color image (YCbCr 4:2:2) data is down sampled in a length direction by the CSC unit 622 of the encoding unit 620 to be converted into a color image (YCbCr 4:2:0) and then output in step S704.

Next, in step S706, the color image (YCbCr 4:2:0) down-sampled by the encoder 624 of the encoding unit 620 and the image processing result data output from the image processing unit 612 are encoded. At this time, data of a new color image (YCbCr 4:2:2) format is generated by including distance information included in the image processing result data in the color image (YCbCr 4:2:0).

The generated new color image (YCbCr 4:2:2) data is then transmitted to the central processing unit 630 via a data bus in step S708. Next, in step S710, the decoder 632 in the central processing unit 630 decodes the new color image (YCbCr 4:2:2) data to separately extract the image processing result data, i.e., distance information, from the color image (YCbCr 4:2:0).

Meanwhile, in image processing of a computer, most of JPG or BMP files are mainly utilized as an input. In particular, in case of using an output of a web camera or digital camera, JPG files are mainly used as an input. Thus, it is known that YCbCr 4:2:0 image format is utilized in the image processing.

Therefore, it is to be noted that, although embodiments of the present invention will be described below with respect to only a 3D camera used in image processing by using a color image of YCbCr 4:2:0 and distance information, the present invention is not limited to the 3D camera but may be applied to any of image processing devices for transmitting and receiving the color image and image processing result data via one bus, and then performing decoding processing.

In accordance with an embodiment of the present invention, a color image of YCbCr 4:2:0 having a certain resolution and other information may be encoded and decoded into one YCbCr 4:2:2 format. The number of bits that may be assigned per one pixel is total 16 bits in the YCbCr 4:2:2 format, and the number of bits that may be assigned per one pixel in the YCbCr 4:2:0 format is 12 bits. Thus, other information of 4 bits per pixel may be included.

For instance, in the case of a 3D camera device that simultaneously outputs a YCbCr 4:2:0 image having a resolution of a width 640 and a length 480 and distance information of maximum 256 levels per pixel, when 4 bits are given per pixel and four pixels are within one group, 16 bits can be assigned and distance information of two pixels per group can be stored. Thus, it is required to perform ½ down sampling in a width or length direction. In case the of distance information, there are actually many instances enough to achieve a desired application result even if it is lower than an actual resolution except applications requiring a very precise result, like factory automation. Therefore, in an application that an amount of information required per pixel is lower than 4 bits (for example, an application that the result of edge detection is on/off and thus 1 bit is sufficient), a down sampling is not required.

While the invention has been shown and described with respect to the embodiments, it will be understood by those skilled in the art that various changes and modification may be made without departing from the scope of the invention as defined in the following claims.

What is claimed is:

1. A coding apparatus for simultaneous transmission of image processing information and color information, the apparatus comprising:
an image sensor for photographing a color image;
an image preprocessing device for performing image processing on the photographed color image, and then encoding image processing result data and the color image to output encoded data; and
a central processing unit for decoding the encoded data to extract the image processing result data and the color image.

2. The apparatus of claim 1, wherein the image preprocessing device includes:
an image processing unit for performing image processing on the photographed color image received from the image sensor; and
an encoding unit for down-sampling the color image, and then encoding a down-sampled color image and an image processing result data output from the image processing unit, and transmitting encoded data generated through the encoding to the central processing unit.

3. The apparatus of claim 2, wherein the image processing unit performs image optimization through noise removal and by controlling at least one of white valance, colors, saturation and contrast using predetermined values, and
outputs information on a distance from the color image to an object to be photographed.

4. The apparatus of claim 3, wherein the distance information is calculated by using at least one of color images with a predetermined time difference or different horizontal distances, and color images output from two lens or multiple image sensors.

5. The apparatus of claim 2, wherein the encoding unit includes:
a color space conversion unit for converting a format of the color image by down-sampling the format of the color image in a length direction; and
an encoder for encoding distance information of the image processing result data output from the image processing unit and a down-sampled color image to thereby generate the encoded data having a new color image format.

6. The apparatus of claim 1, wherein the encoded data is data of YCbCr 4:2:2 format that the image processing result data is included in the down-sampled color image that has four Y values, one Cb and one Cr in four pixels group.

7. The apparatus of claim 1, wherein the color information is encoded by YCbCr 4:2:0 format.

8. The apparatus of claim 1, wherein the image processing result data is encoded by YCbCr 0:0:2 format.

9. The apparatus of claim 1, wherein the image preprocessing device transmits and receives data via one data bus interface with the image sensor and the central processing unit, respectively.

10. The apparatus of claim 1, wherein the image sensor is a camera that outputs the image in YCbCr format.

11. A coding method for simultaneous transmission of image processing information and color information, the method comprising:
photographing a color image by an image sensor;
performing, at an image preprocessing device, image processing on the photographed color image, and then encoding image processing result data and the color image; and
decoding, at a central processing unit, the encoded data to extract the image processing result data and the color image.

12. The method of claim 11, wherein said encoding image processing result data includes:
receiving, at the image preprocessing device, the photographed color image from the image sensor, and performing image processing on the color image at an image processor;
down-sampling the color image, and then encoding a down-sampled color image and an image processing result data output through the image processing; and
transmitting encoded data generated through the encoding to the central processing unit.

13. The method of claim 12, wherein said performing image processing includes:
performing image optimization through noise removal and by controlling at least one of white valance, colors, saturation and contrast using predetermined values, and
outputting information on a distance from the color image to an object to be photographed.

14. The method of claim 13, wherein said outputting distance information includes calculating the distance information by using at least one of color images with a predetermined time difference or different horizontal distances, and color images output from two lens or multiple image sensors.

15. The method of claim 11, wherein said encoding image processing result data includes:
converting, at a color space conversion unit, a format of the color image by down-sampling the format of the color image in a length direction; and
encoding, at an encoder, distance information of the image processing result output through the image processing and a down-sampled color image to thereby generate the encoded data having a new color image format.

16. The method of claim 11, wherein the encoded data is data of YCbCr 4:2:2 format that the image processing result data is included in the down-sampled color image that has four Y values, one Cb and one Cr in four pixel groups.

17. The method of claim 11, wherein the color information is encoded by YCbCr 4:2:0 format.

18. The method of claim 11, wherein the image processing result data is encoded by YCbCr 0:0:2 format.

19. The method of claim 12, wherein said transmitting encoded data transmits and receives data via one data bus interface.

20. The method of claim 11, wherein the image sensor outputs the image in YCbCr format.
